(19) United States
(12) Patent Application Publication
(10) Pub. No.: US 2006/0277337 A1
(43) Pub. Date: Dec. 7, 2006

(54) Conversion interface for memory device

(75) Inventors: Shih-Jen Chuang, Hsin Chu (TW); Chih-Fu Tsai, Hsin Chu (TW); Shu-Min Liu, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/235,807

(22) Filed: Sep. 26, 2005

(30) Foreign Application Priority Data
Jun. 2, 2005 (TW) 094118112

(51) Int. Cl. G06F 13/38; G06F 13/12

(52) U.S. Cl. 710/62

(57) ABSTRACT

A conversion interface of memory device is provided for converting a current operating command of a user's software program to an operating command capable of being executed by the memory device. The conversion interface includes a command decoding module and a command generating module. The command decoding module receives the operating command of the user's software program and decodes the operating command to a decoding command, such that the command generating module generates the operating command capable of being executed by the memory device according to the decoding command. This can realize compatibility between a current software program and a new type of memory device, thereby effectively reducing the design costs and product development cycle and providing great flexibility in design.

### FIELD OF THE INVENTION

The present invention relates to conversion interfaces for memory devices, and more particularly, to a conversion interface that enables software compatibilities between different types of flash memories.

### BACKGROUND OF THE INVENTION

Semiconductors, memories and microprocessors together have established the growth of semiconductor industry in the past twenty years. Unlike other products, such as analog semiconductors, the prices of memories have experienced several dramatic cycles. However, the application demands for memories have increased constantly through the years, from simple consumer type products, such as Personal Computers (PCs), mobile phones, Personal Digital Assistances (PDAs), to more complicated basic infrastructures, such as routers, high-speed switches and storage apparatus.

Currently there are many kinds of memories, but which can be divided into two main types: volatile and non-volatile memories. Flash memory is one of the most common types of non-volatile memories, which rapidly gains its marketplace in the last five to six years fueled by the emergence of consumer products, such as digital cameras, mobile phones, PDAs and MP3 players. Main functions of a general flash memory include reading, writing and erasing. Flash memories widely employed in the market now are NAND-type flash memories or NOR-type flash memories, the main interfaces of which are address port, data port, output enable port, write enable port, and chip enable port. These ports require a large number of pins to be designed in the flash memories, which occupy large spaces in system boards and increase power consumption and costs.

Additionally, along the enhancement of network speed, demands for memories increase day by day. Many different types of flash memories are developed based on the current ones, such as those developed for NOR-type flash memories, including Low-Pin-Count (LPC) NOR-type flash memories, Serial-Port-Interface (SPI) flash memories and Parallel flash memories, reducing occupied space in a system board, power consumption and cost. The software program for the LPC flash memory is designed in the same way as that for the parallel flash memory, so that the software program for the parallel flash memory is compatible with the LPC flash memory without any modifications. However, register definitions of the SPI flash memory and the NAND-type flash memory are different from that for the parallel flash memory, thus a modification of the software program for the parallel flash memory or a newly designed software program tailed for the SPI flash memory and the NAND-type flash memory is needed. This results in large consumptions of human resources and materials to design a new software program or make modification on an existing one. Thus, it increases design cost and prolongs design times and product development cycles.

Therefore, there is needed a conversion interface for memory devices to realize software program compatibilities between different types of flash memories to avoid design inconveniences, human resource consumptions, increased design costs and prolonged product development cycles.

### SUMMARY OF THE INVENTION

In the light of forgoing drawbacks, an objective of the present invention is to provide a conversion interface for memory devices to provide convenience to software designing.

Another objective of the present invention is to provide a conversion interface for memory devices that reduces design cost and product development cycle and enhances design flexibility.

In accordance with the above and other objectives, the present invention provides a conversion interface for a memory device to convert an operating command of a first type of a user's software program into an operating command of a second type of the memory device. The conversion interface for the memory device comprises: a command decoding module for decoding the operating command of the first type of the user's software program to generate a decoding command; and a command generating module for generating the operating command of the second type executable by the memory device based on the decoding command generated by the command decoding module.

The conversion interface for the memory device as described above further comprises a storage module for storing a first mapping table representing a mapping relationship between the operating command of the first type and the decoding command. The command decoding module looks up the first mapping table to obtain the decoding command to be outputted corresponding to the operating command of the first type. Additionally, the storage module further stores a second mapping table representing a mapping relationship between the decoding command and the operating command of the second type. The command generating module looks up the second mapping table to obtain the operating command of the second type to be executed by the memory device corresponding to the decoding command.

Moreover, in another embodiment of the present invention, the command decoding module may also directly perform a logical operation on the operating command of the first type to generate the decoding command to be executed by the command generating module. The command generating module may also perform a logical operation on the decoding command to generate the operating command of the second type to be executed by the memory device.

Compared to the prior art, the conversion interface of the present invention converts an operating command of a first type of a user's program into an operating command of a second type executable by a memory device via a conversion interface constituted by the command decoding module and the command generating module. Thus, through the structure of the present invention, the software designers do not need to modify existing software program or redesign a new program. Thereby, human resources and design cost can be greatly reduced and design flexibility can be improved. Moreover, the product development cycle of a new type of flash memory can be shortened.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing a structure of the conversion interface for memory devices of the present invention.

### DETAILED DESCRIPTION OF THE EMBODIMENTS

The present invention is described by the following specific embodiments. Those with ordinary skills in the arts can readily appreciate the other advantages and effects of the present invention having read the disclosure of this specification. The present invention can also be implemented with different embodiments. Various details described in this specification can be modified based on different viewpoints and applications without departing from the scope of the present invention.

The primary objective of the present invention is to provide a conversion interface of memory devices, which enables software compatibility between different types of flash memory. In order to simplify diagrams and descriptions, compatibility between different types of memories is described in terms of a software program for the parallel flash memory and a software program for the SPI flash memory or NAND-type flash memory, but the present invention is not limited to these types of memories only.

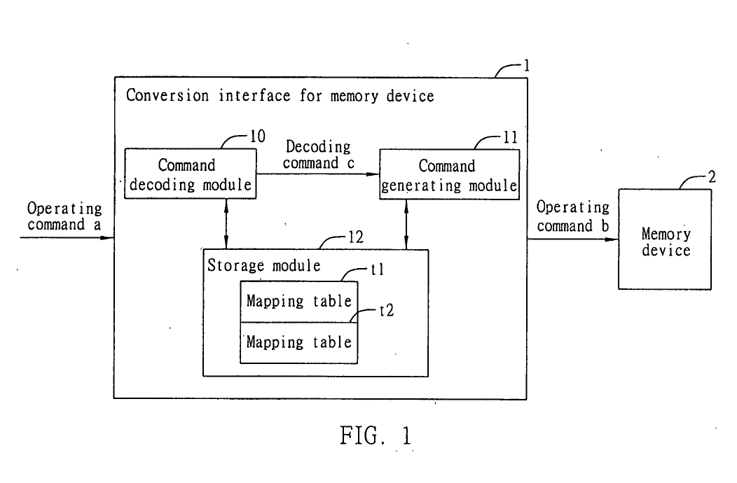

Referring to FIG. 1, a schematic diagram describing a structure of a conversion interface of a memory device of the present invention is shown. The conversion interface 1 of the memory device is used to convert operating commands a of a software program of a parallel flash memory into operating commands b that can be executed by a memory device 2 (i.e. a NAND-type flash memory or a SPI flash memory). The conversion interface 1 of the memory device comprises a command decoding module 10 and a command generating module 11.

The command decoding module 10 is used to receive the operating commands a of the parallel flash memory, perform a decoding process on the operating commands a to generate decoding commands c and output the decoding commands c to the command generating module 11. Specifically, the command decoding module 10 translates the received operating commands a into internal operating codes (i.e. the decoding commands c described above) executable by the command generating module 11. Also, a validity test can be further performed on the operating commands a. The command decoding module 10 is a command decoder. The command decoder can also be replaced by other electronic components or electrical circuits depending on actual applications.

The command generating module 11 generates the operating commands b based on the received decoding commands c, so as to control various operations of a memory device 2, such as reading, writing or erasing operations. More specifically, the command generating module 11 generates the operating commands b based on the internal operating codes executable by the command generating module 11 generated by the command decoding module 10 to control internal operations of the memory device 2. The above command generating module 11 is a command generator. The command generator can also be replaced by other electronic components or electrical circuits depending on actual applications.

Moreover, the command decoding module 10 and the command generating module 11 performs corresponding actions via lookup tables. Thus, the conversion interface 1 of the present invention further comprises a storage module 12. The storage module 12 stores a mapping table t1 representing mapping relationships between operating commands a and decoding commands c and a mapping table t2 representing mapping relationships between decoding commands c and operating commands b, wherein the operating commands a and the decoding commands c are one-to-one mappings and are defined and stored in advance in the storage module 12 by a designer. The decoding commands c and the operating commands b are one-to-one mappings and are defined and stored in advance in the storage module 12 by the designer. During operations of the conversion interface 1, the command decoding module 10 searches a corresponding decoding command c from the mapping table t1 according to a received operating command a. The decoding command c is outputted to be executed by the command generating module 11. Additionally, the command decoding module 10 may also performs a validity test on the received operating command a. Then, the command generating module 11 searches a corresponding operating command b from the mapping table t2 according to the received operating command a. The operating command b is outputted to be executed by the memory device 2.

Furthermore, in the present invention, the command decoding module 10 can also directly perform corresponding decoding processes based on operating commands a of the software program of the parallel flash memory, for example, the command decoding module 10 can be a combinational logic decoder, which performs logic operations on the received operating commands a to generate decoding commands c to be executed by the command generating module 11. Similarly, the command generating module 11 can also directly perform corresponding processes based on the received decoding commands c, for example, the command generating module 11 can be a combinational logic command generator, which performs logic operations on the received decoding commands c to generate operating commands b to be executed by the memory device 2.

Therefore, the conversion interface 1 of the present invention achieves software compatibility between the parallel flash memory and the SPI flash memory by converting operating commands a of the software program of the parallel flash memory into operating commands b executable by another memory device, such as the SPI flash memory, via the conversion interface constituted by the command decoding module 10 and the command generating module 11. This facilitates design of software. Meanwhile, through the use of the conversion interface of the present invention, the software designers do not need to modify existing software program (such as a software program of a parallel flash memory) or redesign a new program tailored for the SPI or NAND-type flash memory Thereby, human resources and design cost can be greatly reduced and design flexibility can be improved. Moreover, the product development cycle of a new type of flash memory can be shortened. Thus, avoiding problems encountered in the prior art as described before.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A conversion interface for a memory device, for converting an operating command of a first type of a user's software program into an operating command of a second type of the memory device, the conversion interface comprising:
a command decoding module for decoding the operating command of the first type of the user's software program to generate a decoding command; and
a command generating module for generating the operating command of the second type executable by the memory device based on the decoding command generated by the command decoding module.

2. The conversion interface of claim 1, further comprising a storage module for storing a first mapping table representing a mapping relationship between the operating command of the first type and the decoding command.

3. The conversion interface of claim 2, wherein the command decoding module looks up the first mapping table to obtain the decoding command to be outputted corresponding to the operating command of the first type.

4. The conversion interface of claim 2, wherein the storage module further stores a second mapping table representing a mapping relationship between the decoding command and the operating command of the second type.

5. The conversion interface of claim 4, wherein the command generating module looks up the second mapping table to obtain the operating command of the second type to be outputted corresponding to the decoding command and to be executed by the memory device.

6. The conversion interface of claim 1, wherein the command decoding module is a command decoder.

7. The conversion interface of claim 1, wherein the command generating module is a command generator.

8. The conversion interface of claim 1, wherein the command decoding module is a combinational logic decoder that performs a logical operation on the received operating command of the first type in order to generate the decoding command.

9. The conversion interface of claim 1, wherein the command generating module is a combinational logic generator that performs a logical operation on the received decoding command in order to generate the operating command of the second type to be executed by the memory device.

10. The conversion interface of claim 1, wherein the memory device is a flash memory.

11. The conversion interface of claim 10, wherein the flash memory is a Serial Port Interface (SPI) NOR-type flash memory.

12. The conversion interface of claim 10, wherein the flash memory is a NAND-type flash memory.
